(19) United States
(12) Patent Application Publication
(10) Pub. No.: US 2013/0156426 A1
(43) Pub. Date: Jun. 20, 2013

(54) LOW POWER OPTICAL NETWORK TERMINAL AND METHOD OF OPERATING LOW POWER OPTICAL NETWORK TERMINAL

(71) Applicants: Geun Yong KIM, Gyeonggi-do (KR); Sung Chang Kim, Gwanju (KR); Mun Seob Lee, Daejeon (KR); Hark Yoo, Gwangju (KR); Young Suk Lee, Gwangju (KR); Dong Soo Lee, Gwangju (KR)

(72) Inventors: Geun Yong KIM, Gyeonggi-do (KR); Sung Chang Kim, Gwanju (KR); Mun Seob Lee, Daejeon (KR); Hark Yoo, Gwangju (KR); Young Suk Lee, Gwangju (KR); Dong Soo Lee, Gwangju (KR)

(73) Assignee: Electronics and Telecommunications Research Institute, Daejeon (KR)

(21) Appl. No.: 13/596,330

(22) Filed: Aug. 28, 2012

(30) Foreign Application Priority Data
Dec. 15, 2011 (KR) 10-2011-0135283

(51) Int. Cl. H04B 10/20

(52) U.S. Cl. 398/45

(57) ABSTRACT

Disclosed is a low power optical network terminal (ONT) and a method of operating the low power ONT. The low power ONT may include a network media access control (MAC) processing unit to transmit and receive traffic to and from an optical line terminal (OLT), a switching unit to receive the traffic transmitted from the network MAC processing unit and transmit the traffic to a subscriber terminal and to receive the traffic from the subscriber terminal and transmit the traffic to the OLT, and a control unit to control traffic transmission from the network MAC processing unit when a power mode is a low power mode.

### CROSS-REFERENCE TO RELATED APPLICATION

This application claims the priority benefit of Korean Patent Application No. 10-2011-0135283, filed on Dec. 15, 2011, in the Korean Intellectual Property Office, the disclosure of which is incorporated herein by reference.

### BACKGROUND

1. Field of the Invention

Exemplary embodiments of the present invention relate to a low power optical network terminal (ONT) and a method of operating the low power ONT that may power off a component associated with network media access control (MAC) processing when a power mode is a low power mode, to improve efficiency in reducing power consumption.

2. Description of the Related Art

An optical line terminal (OLT) may transmit traffic, for example, multicast traffic, to an optical network terminal (ONT). In this instance, when a traffic request from a subscriber terminal is absent or when a power mode is a low power mode, the ONT does not need to transmit the traffic received from the OLT to the subscriber terminal.

However, even though the ONT does not need to transmit multicast traffic to the subscriber terminal, the ONT may fully power on a component or function associated with traffic transmission to the subscriber terminal which may result in poor utilization of power.

FIG. 1 illustrates a configuration of an ONT 101 according to a related art.

Referring to FIG. 1, the ONT 101 may include a network media access control (MAC) processing unit 103 and a switching unit 105.

The network MAC processing unit 103 may transmit traffic received from an OLT 107 to the switching unit 105. In this instance, even though the traffic does not need to be transmitted to a subscriber terminal 109, the network MAC processing unit 103 may transmit the traffic to the switching unit 105 unconditionally.

When a traffic request from the subscriber terminal 109 is present, the switching unit 105 may transmit the traffic to the subscriber terminal 109, and when a traffic request from the subscriber terminal 109 is absent, the switching unit 105 may not transmit the traffic to the subscriber terminal 109.

Accordingly, even though traffic does not need to be transmitted to the subscriber terminal 109 or a power mode is a low power mode, the ONT 101 may fully power on the network MAC processing unit 103 and the switching unit 105, which may result in waste of power.

### SUMMARY

An aspect of the present invention is to improve efficiency in reducing power consumption by controlling, when a power mode of a low power optical network terminal (ONT) is a low power mode, power of a component associated with network media access control (MAC) processing as well as power of an optical transmitting unit and an optical receiving unit associated with communication with an optical line terminal (OLT).

Another aspect of the present invention is to maximize efficiency in reducing power consumption by further controlling, when a power mode of a low power ONT is a low power mode, power of a component of a switching unit associated with communication with a subscriber terminal.

According to an aspect of the present invention, there is provided a low power ONT including a network MAC processing unit to transmit traffic to and receive traffic from an OLT, a switching unit to receive the traffic transmitted from the network MAC processing unit and transmit the traffic to a subscriber terminal and to receive the traffic from the subscriber terminal and transmit the traffic to the OLT, and a control unit to control traffic transmission from the network MAC processing unit when a power mode is a low power mode.

According to another aspect of the present invention, there is provided a method of operating a low power ONT, including receiving, by a network MAC processing unit in the low power ONT, traffic from an OLT, controlling, by a control unit in the low power ONT, traffic transmission from the network MAC processing unit when a power mode is a low power mode, and when the power mode is out of the low power mode, allowing the network MAC processing unit to transmit the traffic, and receiving, by a switching unit in the low power ONT, the transmitted traffic and transmitting the traffic to a subscriber terminal when the traffic is transmitted.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a configuration of a low power optical network terminal (ONT) according to a related art;

FIG. 2 is a diagram illustrating a configuration of an optical subscriber network system according to an embodiment of the present invention;

FIG. 3 is a diagram illustrating a configuration of a low power ONT according to an embodiment of the present invention;

FIG. 4 is a diagram illustrating an example of a configuration of a low power ONT according to an embodiment of the present invention; and

FIG. 5 is a flowchart illustrating a method of operating a low power ONT according to an embodiment of the present invention.

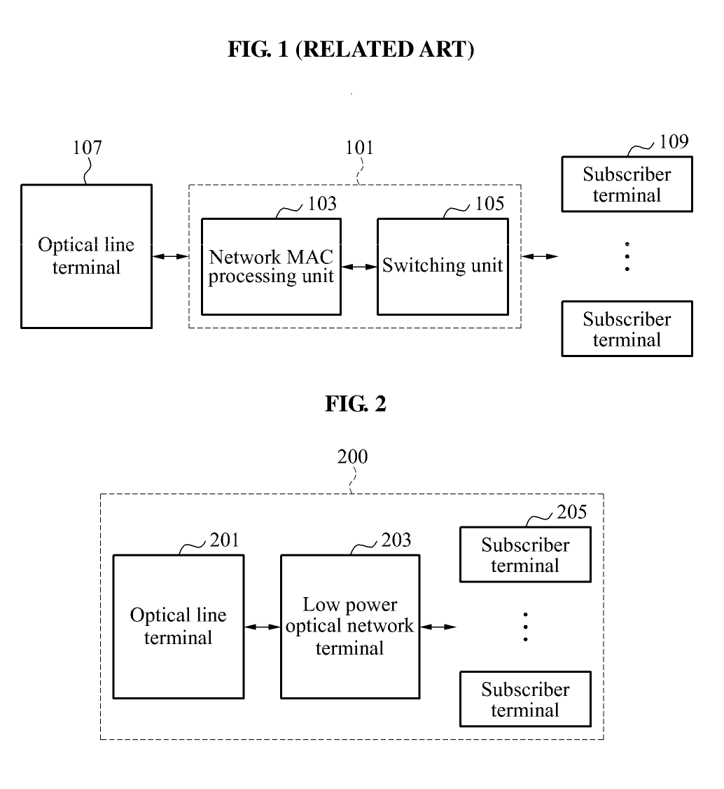

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

Exemplary embodiments of the present invention provide a low power optical network terminal (ONT) and a method of operating a low power ONT.

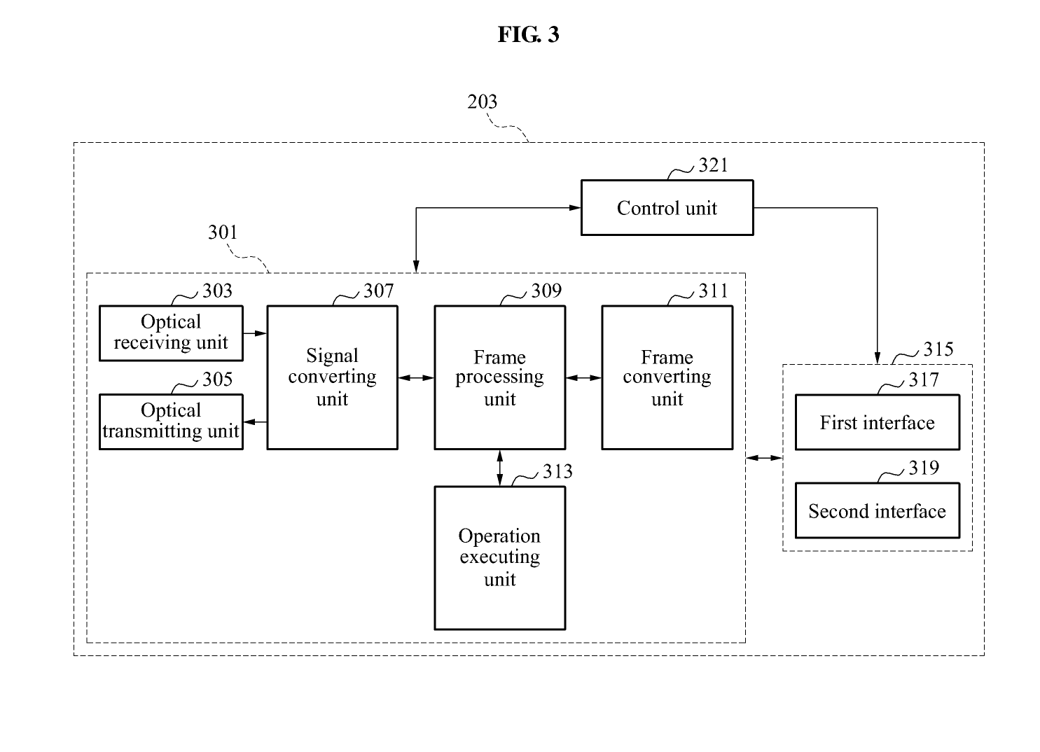

FIG. 2 is a diagram illustrating a configuration of an optical subscriber network system 200 according to an embodiment of the present invention.

Referring to FIG. 2, the optical subscriber network system 200 may include an optical line terminal (OLT) 201, a low power ONT 203, and a subscriber terminal 205.

When the low power ONT 203 satisfies a condition for switching to a low power mode, for example, a sleep mode, the OLT 201 may transmit a low power mode switching request message, for example, a physical layer operation, administration, and maintenance (PLOAM) message, to the low power ONT 203.

When the low power ONT 203 switches to a low power mode, the OLT 201 may receive a low power mode switching completion message in response to the low power mode switching request message.

Also, when the low power ONT 203 is determined to be unable to maintain a low power mode, for example, a call request from an external voice over Internet protocol (VoIP) telephone is present, the OLT 201 may transmit a normal mode switching request message, for example, a PLOAM message, to the low power ONT 203.

When the low power ONT 203 switches to a normal mode, the OLT 201 may receive a normal mode switching completion message from the low power ONT 203.

The OLT 201 may manage the power mode of the low power ONT 203, that is, a low power mode and a normal mode, based on a switching completion message received from the low power ONT 203.

When the low power ONT 203 receives a low power mode switching request message from the OLT 201, in a case in which the low power ONT 203 is able to be switched to a low power mode in which traffic does not have to be transmitted to the subscriber terminal 205, the low power ONT 203 may switch to the low power mode and may transmit a low power mode switching completion message to the OLT 201.

When the low power ONT 203 is determined to be unable to maintain a low power mode while operating in the low power mode and when the low power ONT 203 receives a normal mode switching request message from the OLT 201, the low power ONT 203 may switch from a low power mode to a normal mode. In this instance, the low power ONT 203 may be determined to be unable to maintain a low power mode when the low power ONT 203 receives a traffic request, for example, a multi-traffic request from the subscriber terminal 205, for example, when a desktop computer is turned on, a call request form a VoIP telephone is present, and an Internet protocol television (IPTV) is turned on.

After the low power ONT 203 switches to a normal mode, the low power ONT 203 may transmit a normal mode switching completion message, for example, a PLOAM message to the OLT 201.

The subscriber terminal 205 may transmit traffic to and receive traffic from the low power ONT 203 in response to a request by a user.

FIG. 3 is a diagram illustrating a configuration of the low power ONT 203 according to an embodiment of the present invention.

Referring to FIG. 3, the low power ONT 203 may include a network media access control (MAC) processing unit 301, a switching unit 315, and a control unit 321. In this instance, the low power ONT 203 may support downstream communication by transmitting traffic received from the OLT to the subscriber terminal and may support an upstream communication by transmitting traffic received from the subscriber terminal to the OLT.

The network MAC processing unit 301 may transmit traffic to and receive traffic from the OLT. In this instance, the network MAC processing unit 301 may include an optical receiving unit 303, an optical transmitting unit 305, a signal converting unit 307, a frame processing unit 309, a frame converting unit 311, and an operation executing unit 313.

The optical receiving unit 303 may receive an optical signal from the OLT and may transmit the optical signal to the signal converting unit 307.

The optical transmitting unit 305 may transmit an optical signal converted by the signal converting unit 307 to the OLT.

The signal converting unit 307 may convert an optical signal received from the OLT into an electrical signal and may convert an electrical signal to be transmitted to the OLT into an optical signal.

The frame processing unit 309 may analyze a frame of a first format converted into an electrical signal.

The frame converting unit 311 may convert a frame of a first format, for example, an 10-gigabit-capable passive optical network (XG-PON) transmission convergence (XGTC) frame, received from the frame processing unit 309 into a frame of a second format, for example, an XG-PON encapsulation method (XGEM) frame, and may transmit the frame of the second format to the switching unit 315, and the frame converting unit 311 may convert a frame of a second format received from the switching unit 315 into a frame of a first format and may transmit the frame of the first format to the frame processing unit 309.

The operation executing unit 313 may execute an operation based on the analysis result by the frame processing unit 309.

The switching unit 315 may receive traffic transmitted from the network MAC processing unit 301 and transmit the traffic to the subscriber terminal, and may receive traffic from the subscriber terminal and transmit the traffic to the OLT. In this instance, the switching unit 315 may include a first interface 317 to receive traffic from the network MAC processing unit 301 and transmit the traffic to the subscriber terminal, and a second interface 319 to receive traffic from the subscriber terminal and transmit the traffic to the network MAC processing unit 301.

The switching unit 315 may communicate with N subscriber terminals through a subscriber port, wherein N is a natural number, and when the switching unit 315 receives a traffic request from at least one of the N subscriber terminals, may transmit the traffic request to the control unit 321.

When the control unit 321 receives a low power mode switching request message from the ONT, the control unit 321 may switch to a low power mode. When the power mode is a low power mode, the control unit 321 may control traffic transmission from the network MAC processing unit 301.

When the power mode is a low power mode, the control unit 321 may control power of at least one of the optical receiving unit 303 and the optical transmitting unit 305. For example, when the power mode is a low power mode, for example, a doze sleep mode, the control unit 321 may control operation of the optical transmitting unit 305 by powering off the optical transmitting unit 305. When the power mode is a low power mode, for example, a cyclic sleep mode, the control unit 321 may control operation of the optical receiving unit 303 and the optical transmitting unit 305 by powering off the optical receiving unit 303 and the optical transmitting unit 305.

When the power mode is a low power mode, the control unit 321 may control operation of the frame converting unit 311 by powering off the frame converting unit 311. Accordingly, the control unit 321 may improve efficiency in reducing power consumption by controlling power of the frame converting unit 311 that is a component associated with network MAC processing, as well as the optical receiving unit 303 and the optical transmitting unit 305.

Also, when the power mode is a low power mode, the control unit 321 may control operation of the first interface 317 by powering off the first interface 317, and may maintain operation of the second interface 319 by powering on the second interface 319. The control unit 321 may control operation of the first interface 317 by powering off the first interface 317 to maximize efficiency in reducing power consumption, and may maintain operation of the second interface 319 by powering on the second interface 319 to ensure an environment in which traffic transmitted from the subscriber terminal may be received all the way in a low power mode.

When the control unit 321 receives a traffic request from the switching unit 315, the control unit 321 may switch the power mode to a normal mode to allow the network MAC processing unit 301 to transmit traffic that may be transmitted to the subscriber terminal.

Accordingly, the low power ONT according to the exemplary embodiments of the present invention may improve efficiency in reducing power consumption by powering off a component associated with traffic transmission to the subscriber terminal, for example, the frame converting unit and the first interface, when the power mode is a low power mode in which traffic does not have to be transmitted to the subscriber terminal.

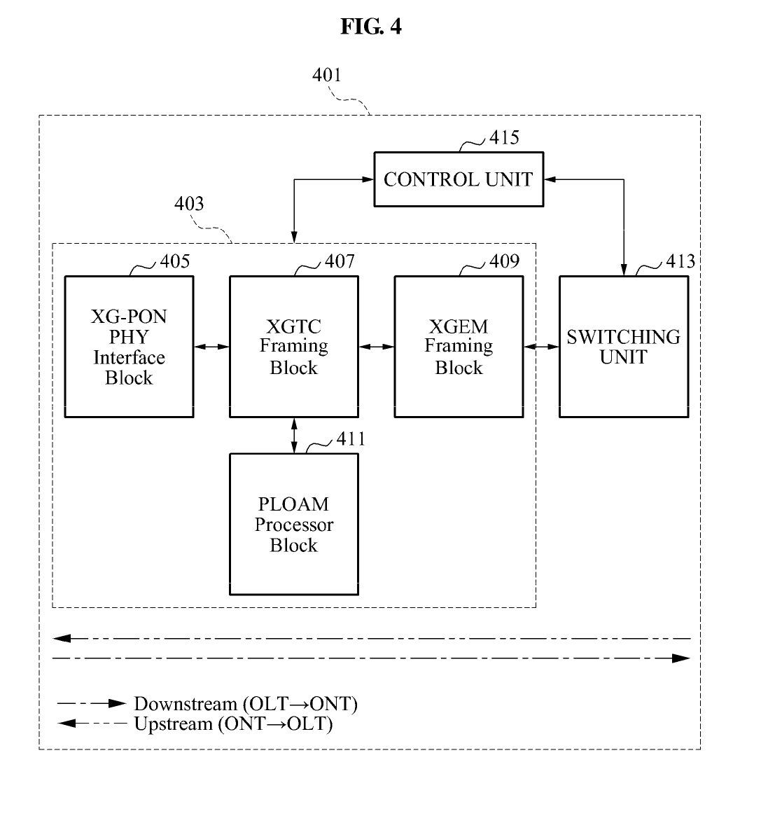

FIG. 4 is a diagram illustrating an example of a configuration of a low power ONT 401 according to an embodiment of the present invention.

Referring to FIG. 4, the low power ONT 401 may include a network MAC processing unit 403, a switching unit 413, and a control unit 415.

The network MAC processing unit 403 may operate in accordance with a passive optical subscriber network standard.

The network MAC processing unit 403 may include, for example, an XG-PON physical (PHY) interface block 405, an XGTC framing block 407, an XGEM framing block 409, and a PLOAM processor block 411.

The XG-PON PHY interface block 405 may convert an optical signal into an electrical signal in a downstream direction, that is, in a transmission direction from the OLT to the ONT, and may convert an electrical signal into an optical signal in an upstream direction, that is, in a transmission direction from the ONT to the OLT. The optical transmitting unit or the optical receiving unit associated with the XG-PON PHY interface block 405 may be powered on and off repeatedly, depending on a doze sleep mode or a cyclic sleep mode.

The XGTC framing block 407 may classify and interpret each field of an XGTC frame in a downstream direction, and may assemble an XGEM frame into an XGTC frame in an upstream direction. The XGTC framing block 407 may receive a message, for example, a PLOAM message in a sleep mode, and may interpret a header of a downstream XGTC frame and recognize a forced wakeup indication (FWI) bit.

The XGEM framing block 409 may interpret a header of an XGEM frame and convert the XGEM frame into an Ethernet frame through separating and reassembling data in a downstream direction, and may encapsulate an Ethernet frame received from the switching unit 413 into an XGEM frame in an upstream direction.

The PLOAM processor block 411 may parse a message, for example, a PLOAM message, received by the XGTC framing block 407, and may operate in accordance with a standard, for example, a G.987.3 standard.

The switching unit 413 may correspond to a function block to transmit an Ethernet traffic received from the network MAC processing unit 403 to the subscriber terminal, and may implement, for example, a Layer 2/Layer 3 protocol of an open systems interconnection (OSI) 7 layer model.

The control unit 415 may control operation of the network MAC processing unit 403 and the switching unit 413 by enabling, for example, powering on, and disabling, for example, powering off the network MAC processing unit 403 and the switching unit 413.

That is, the control unit 415 may enable the XG-PON PHY interface block 405, the XGTC framing block 407, and the PLOAM processor block 411, irrespective of a power mode.

Also, when the power mode is a normal mode, the control unit 415 may enable the

XGEM framing block 409 and the switching unit 413, and when the power mode is a sleep mode, may disable the XGEM framing block 409 and the switching unit 413. When the power mode is a sleep mode in which traffic is not transmitted to the subscriber terminal, the control unit 415 may not operate the XGEM framing block 409. In particular, as the XGEM framing block 409 fails to operate, an external random access memory (RAM) used in data reassembly does not have to operate, which may lead to a greater reduction in power consumption when compared to the other function blocks. Since the control unit 415 does not transmit a downstream traffic to the subscriber terminal, the control unit 415 may not operate a component of the switching unit 413, for example, a PHY chip for Ethernet traffic transmission. However, the control unit 415 may operate the other component of the switching unit 413 to detect upstream traffic transmitted from the subscriber terminal and switch from a sleep mode to a normal mode.

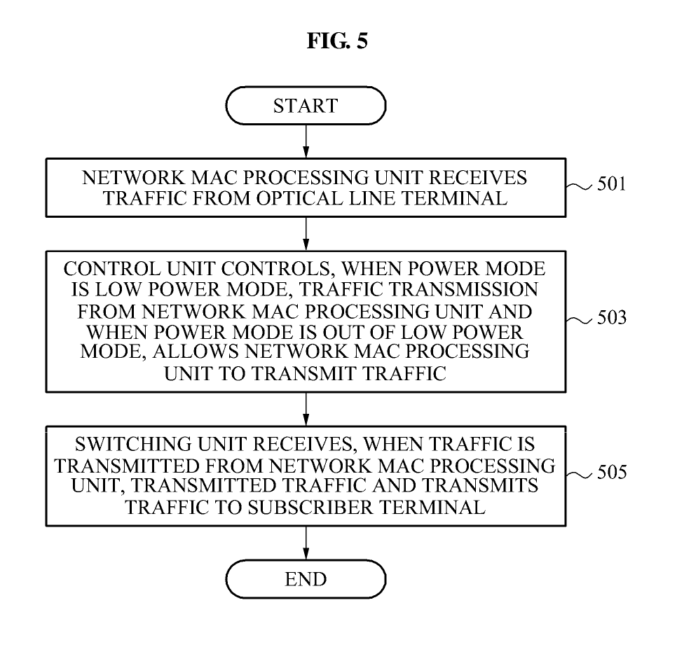

FIG. 5 is a flowchart illustrating a method of operating a low power ONT according to an embodiment of the present invention. In this instance, the low power ONT may include a network MAC processing unit, a switching unit, and a control unit.

Referring to FIG. 5, in operation 501, the network MAC processing unit may receive traffic from an OLT. In this instance, the network MAC processing unit may include a signal converting unit to convert an optical signal received from the OLT into an electrical signal and to convert an electrical signal to be transmitted to the OLT into an optical signal, a frame processing unit to analyze a frame of a first format converted into an electrical signal, a frame converting unit to convert the frame of the first format received from the frame processing unit into a frame of a second format and transmit the frame of the second format to the switching unit, and to convert the frame of the second format received from the switching unit into a frame of a first format and transmit the frame of the first format to the frame processing unit, and an operation executing unit to execute an operation based on the analysis result by the frame processing unit.

In operation 503, when a power mode is a low power mode, the control unit may control traffic transmission from the network MAC processing unit, and when the power mode is out of the low power mode, for example, when the power mode is a normal mode, may allow the network MAC processing unit to transmit the traffic.

In this instance, when the power mode is a low power mode, the control unit may power off a first interface receiving traffic from the network MAC processing unit and transmitting the traffic to a subscriber terminal, to reduce power consumption, and may power on a second interface receiving traffic from the subscriber terminal and transmitting the traffic to the network MAC processing unit, to ensure an environment for responding to a traffic request from the subscriber terminal.

Also, when the power mode is a low power mode, the control unit may control operation of the frame converting unit by powering off the frame converting unit, to reduce power consumption.

In operation 505, when the traffic is transmitted from the network MAC processing unit, the switching unit may receive the transmitted traffic and transmit the traffic to the subscriber terminal.

Subsequently, when the switching unit receives a traffic request from at least one of the N subscriber terminals wherein N is a natural number, the switching unit may transmit the traffic request to the control unit. The control unit may receive the traffic request from the switching unit, and when the power mode is a low power mode, may switch to a normal mode to allow the network MAC processing unit to transmit the traffic to support traffic transmission to the subscriber terminal.

The above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard discs, floppy discs, and magnetic tape; optical media such as CD ROM discs and DVDs; magneto-optical media such as floptical discs; and hardware devices that are specially configured to store and perform program instructions, such as read-only memory (ROM), RAM, flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

According to the exemplary embodiments of the present invention, efficiency in reducing power consumption may be improved by controlling power of a component associated with network MAC processing as well as power of the optical transmitting unit and the optical receiving unit associated with communication with the ONT, when the power mode of the low power ONT is a low power mode.

Also, according to the exemplary embodiments of the present invention, efficiency in reducing power consumption may be maximized by controlling power of a component of the switching unit associated with communication with the subscriber terminal when the power mode of the low power ONT is a low power mode.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A low power optical network terminal (ONT) comprising:
a network media access control (MAC) processing unit to transmit traffic to and receive traffic from an optical line terminal (OLT);
a switching unit to receive the traffic transmitted from the network MAC processing unit and transmit the traffic to a subscriber terminal and to receive the traffic from the subscriber terminal and transmit the traffic to the OLT; and
a control unit to control traffic transmission from the network MAC processing unit when a power mode is a low power mode.

2. The low power ONT of claim 1, wherein the switching unit transmits a traffic request to the control unit when the switching unit receives the traffic request from at least one of N subscriber terminals, wherein N is a natural number, and
when the control unit receives the traffic request from the switching unit, the control unit switches the power mode to a normal mode to allow the network MAC processing unit to transmit the traffic.

3. The low power ONT of claim 1, wherein the network MAC processing unit comprises:
a signal converting unit to convert an optical signal received from the OLT into an electrical signal and to convert an electrical signal to be transmitted to the OLT into an optical signal;
a frame processing unit to analyze a frame of a first format converted into the electrical signal; and
a frame converting unit to convert the frame of the first format received from the frame processing unit into a frame of a second format and transmit the frame of the second format to the switching unit, and to convert the frame of the second format received from the switching unit into a frame of a first format and transmit the frame of the first format to the frame processing unit.

4. The low power ONT of claim 3, wherein the control unit controls operation of the frame converting unit by powering off the frame converting unit.

5. The low power ONT of claim 3, wherein the network MAC processing unit further comprises:
an optical transmitting unit to transmit the converted optical signal to the OLT, and
the control unit controls operation of the optical transmitting unit by powering off the optical transmitting unit when the low power mode is a doze sleep mode.

6. The low power ONT of claim 3, wherein the network MAC processing unit further comprises:
an optical receiving unit to receive the optical signal from the OLT; and
an optical transmitting unit to transmit the converted optical signal to the OLT,
the control unit controls operation of the optical receiving unit and the optical transmitting unit by powering off the optical receiving unit and the optical transmitting unit when the low power mode is a cyclic sleep mode.

7. The low power ONT of claim 1, wherein the switching unit comprises a first interface to receive the traffic from the network MAC processing unit and transmit the traffic to the subscriber terminal, and a second interface to receive the traffic from the subscriber terminal and transmit the traffic to the network MAC processing unit, and
the control unit controls operation of the first interface by powering off the first interface, and maintains operation of the second interface by powering on the second interface.

8. A method of operating a low power optical network terminal (ONT), the method implemented by the low power ONT, the method comprising:
receiving, by a network multi access computer (MAC) processing unit in the low power ONT, traffic from an optical line terminal (OLT);
controlling, by a control unit in the low power ONT, traffic transmission from the network MAC processing unit when a power mode is a low power mode, and when the power mode is out of the low power mode, allowing the network MAC processing unit to transmit the traffic; and
receiving, by a switching unit in the low power ONT, the transmitted traffic and transmitting the traffic to a subscriber terminal when the traffic is transmitted.

9. The method of claim 8, further comprising:
transmitting, by the switching unit, a traffic request to the control unit when the switching unit receives the traffic request from at least one of N subscriber terminals, wherein N is a natural number; and
receiving, by the control unit, the traffic request from the switching unit, and when the power mode is the low power mode, switching the power mode to a normal mode.

10. The method of claim 8, when the power mode is the low power mode, further comprising:
controlling, by the control unit, operation of a first interface by powering off the first interface receiving the traffic from the network MAC processing unit and transmitting the traffic to the subscriber terminal; and
controlling, by the control unit, operation of a second interface by powering on the second interface receiving the traffic from the subscriber terminal and transmitting the traffic to the network MAC processing unit.
